(19) United States
(12) Patent Application Publication
(10) Pub. No.: US 2005/0008526 A1
(43) Pub. Date: Jan. 13, 2005

(54) Liquid activator composition

(75) Inventors: Giulia Ottavia Bianchetti, Rome (IT); Alberto Caselli, Terni (IT); Stefano Resta, Genzano (IT)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/887,037

(22) Filed: Jul. 8, 2004

(30) Foreign Application Priority Data
Jul. 8, 2003 (EP) 03077146.3

(51) Int. Cl. A01N 1/00; C23F 11/00

(52) U.S. Cl. 422/1; 422/28; 422/37; 554/158

(57) ABSTRACT

The present invention relates to a liquid composition comprising a long chain glycerol-based, hydrophobic bleach activator and a hydrophilic bleach activator.

### TECHNICAL FIELD

The present invention relates to liquid activator compositions and in particular to liquid activator compositions for use with peroxygen bleach-containing compositions.

### BACKGROUND OF THE INVENTION

Bleach-containing compositions for treating fabrics are well known in the art. Indeed, peroxygen bleach-containing compositions have been extensively described in the art, especially in laundry applications as laundry additives and/or laundry pretreaters.

Indeed, it is known to use such peroxygen bleach-containing compositions in laundry applications to boost the removal of dried on (encrusted) stains/soils and “problem” stains, such as grease, coffee, tea, grass, mud/clay-containing soils, which are otherwise particularly difficult to remove. In addition, peroxygen bleaches are considered as being safer to fabrics compared to other bleaches, such as hypohalite bleaches.

Bleaching compositions comprising a peroxygen bleach have the inconvenience of showing a somewhat limited bleach performance compared to other bleaches, like hypohalite bleaches. Hence, it is known in the art to use bleach activators in combination with peroxygen bleach-containing compositions. Indeed, several different bleach activators are discussed in the art such as nonanoyloxybenzenesulphonate (NOBS), n-nonanoylsuccinimid (NOSI), N-acyl caprolactams, tetracetyl ethylene diamine (TAED), acetyl triethyl citrate (ATC) or short chain tri-glycerides, such as triacetin.

However, a drawback associated with the use of bleach activators in combination with peroxygen bleach-containing compositions is that depending on the hydrophobicity or hydrophilicity of the bleach activator the bleach performance on hydrophilic or hydrophobic bleachable stains is limited. Indeed, a hydrophobic bleach activator shows good bleach activation performance on hydrophobic bleachable stains, such as burned fats (like butter), tomato-sauce, cosmetics (like lipstick), but limited bleach activation performance on hydrophilic bleachable stains, such as coffee. In addition, a hydrophilic bleach activator shows good bleach activation performance on hydrophilic bleachable stains, but limited bleach activation performance on hydrophobic bleachable stains.

In order to overcome this drawback, it has been found that the use of a combination of a hydrophilic and a hydrophobic bleach activator in combination with a peroxygen bleach-containing composition provides excellent bleach activation performance both on hydrophilic and hydrophobic stains.

However, a problem with the currently used hydrophobic bleach activators, such as NOBS, is the fact that they are solids that need to be suspended in liquid compositions and are thus difficult to formulate. Furthermore, such hydrophobic bleach activators can be expensive raw material. In addition, some of the currently used hydrophobic bleach activators, such as NOBS, are known sensitizers and can cause problems in laundry machines.

It is therefore an objective of the present invention to provide a liquid activator composition that provides good bleach activation performance on both hydrophilic and hydrophobic stains, without showing some of the negative aspects connected to the use of the frequently used hydrophobic bleach activators.

It has now been found that this objective can be met by the liquid composition comprising a long chain glycerol-based, hydrophobic bleach activator and a hydrophilic bleach activator.

Advantageously, the long chain glycerol-based, hydrophobic bleach activator are easy to formulate in the liquid compositions of the present invention due to the fact that they are liquid compounds.

A further advantage of the long chain glycerol-based, hydrophobic bleach activators herein is the fact that they are readily commercially available and relatively inexpensive raw materials.

### BACKGROUND PRIOR ART

EP-A-0 563 460 describes liquid aqueous compositions comprising a short chain (C1-4) di- or tri-glycerides.

EP-A-0 253 487 describes activated oxidant systems comprising an enzyme, C1-12 di- or tri-glycerides as a substrate and a source of active oxygen.

WO 94/03423 describes compositions suitable for bleaching surfactants with a composition comprising triacetin.

JP-A-62001794 and JP-A-62252500 describe compositions comprising a bleach activator such as triacetin.

EP-A-1 125 497 describes disinfectants comprising a peracid and glycerol di- or tri-acetate.

### SUMMARY OF THE INVENTION

The present invention encompasses a liquid composition comprising a long chain glycerol-based, hydrophobic bleach activator and a hydrophilic bleach activator.

### DETAILED DESCRIPTION OF THE INVENTION

The Liquid Composition

The bleaching composition according to the present invention is formulated as a liquid composition. By “liquid” it is meant to include conventional liquids, gels and pastes.

In an alternative embodiment according to the present invention, the liquid composition herein is combined with and/or applied to, preferably sprayed onto, a solid, preferably powder, composition. Therefore, the present invention further encompasses a solid, preferably powder or compressed powder (such as a tablet), composition wherein the liquid composition herein is combined with and/or applied to, preferably sprayed onto, to said solid composition, preferably said powder or compressed powder composition. Alternatively, said liquid composition herein can be added to a solid composition, preferably a powder or compressed powder composition, by means of forming capsules containing the liquid composition herein.

In a preferred embodiment herein, the compositions herein are formulated as aqueous compositions. Preferred liquid aqueous compositions comprise water, more preferably comprise water in an amount of from about 60% to about 98%, even more preferably of from about 80% to about 97% and most preferably about 85% to about 97% by weight of the total composition.

The pH of the liquid aqueous compositions herein may be in the range of from pH about 0 to pH about 14. Preferred pH ranges may vary depending on the ingredients present in the composition as well as it use. Preferred pH ranges are discussed herein under the section titled “Product form”.

In another preferred embodiment, the liquid compositions herein are substantially free of water, preferably free of water, and are thus formulated as non-aqueous compositions. By “substantially free of water” it is meant that no water as such is added to the liquid composition. However, said liquid composition may comprise traces of water added into the composition through the raw-materials used to produce the liquid composition. The level of water added into the composition through the raw-materials used to produce the liquid composition is preferably below about 10%, more preferably below about 5%, even more preferably below about 3% by weight of the total composition.

The compositions herein may further comprise an acid or a base to adjust the pH as appropriate.

Preferred acids herein are organic or inorganic acids or mixtures thereof Preferred organic acids are acetic acid, citric acid or a mixture thereof. Preferred inorganic acids are sulfuric acid, phosphoric acid or a mixture thereof.

Typical levels of such acids, when present, are of from about 0.01% to about 3.0%, preferably from about 0.05% to about 2.0% and more preferably from about 0.1% to about 1.0% by weight of the total composition.

The bases to be used herein can be organic or inorganic bases. Suitable bases for use herein are the caustic alkalis, such as sodium hydroxide, potassium hydroxide and/or lithium hydroxide, and/or the alkali metal oxides such, as sodium and/or potassium oxide or mixtures thereof.

Other suitable bases include ammonia, ammonium carbonate and hydrogen carbonate.

Typical levels of such bases, when present, are of from about 0.01% to about 1.0%, preferably from about 0.05% to about 0.8% and more preferably from about 0.1% to about 0.5% by weight of the total composition.

Long Chain Glycerol-Based, Hydrophobic Bleach Activator

As a first essential ingredient the liquid compositions according to the present invention comprise a long chain glycerol-based, hydrophobic bleach activator.

By “hydrophobic bleach activator” it is meant herein any bleach activator that upon perhydrolysis forms a peracid which is non-hydrophilic, preferably hydrophobic, according to the classification of peracids—into hydrophilic, hydrophobic and hydrotropic ones—reported in Kirk-Ohtmer Encyclopedia of chemical technology 4^{th} edition, vol. 4, pages 284-285.

Preferably the generated peracid or mixture thereof generated by the long chain glycerol-based, hydrophobic bleach activator herein have an HLB of at utmost about 7.5, more preferably of from about 2 to about 7.5, even more preferably of from about 3 to about 7.5 and most preferably of from about 4 to about 7. A suitable way of calculating HLB values is according to Davis, for example, as described in “Surfactants and Polymers in aqueous solution”, 2nd edition, Holmberg K. et. al., Wiley, page 460. Suitable generated peracid or mixture thereof generated by the long chain glycerol-based, hydrophobic bleach activator are selected from the group consisting of: peroctanoic acid (HLB value of 5.78), peresanoic acid (HLB value of 6.73), and perdecanoic acid (HLB value of 4.83) and mixtures thereof.

A suitable long chain glycerol-based, hydrophobic bleach activator is according to the formula: 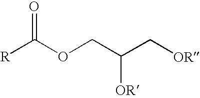
wherein R is a linear or branched, saturated or unsaturated alkyl chain with a number of carbon atoms between about 5 and about 20, or a linear or branched, saturated or unsaturated alkyl aryl chain with a number of carbon atoms between about 9 and about 20 and wherein R′ and R″ are independently —H or —COR′″, with R′″ being a linear or branched, saturated or unsaturated alkyl chain with a number of carbon atoms between about 5 and about 20, or a linear or branched, saturated or unsaturated alkyl aryl chain with a number of carbon atoms between about 9 and about 20.

Preferably R is a linear, saturated alkyl chain having about 8 carbon atoms and R′ and R″ are —COR′″, with R′″ being a linear, saturated alkyl chain having about 8 carbon atoms.

Preferably the long chain glycerol-based, hydrophobic bleach activator herein is selected from the group consisting of: triesanoin; mono- di- or trioctanoin; mono- di- or tridecanoin; and mono- di- or trilaurin and mixtures thereof. More preferably the long chain glycerol-based, hydrophobic bleach activator herein is selected from the group consisting of: triesanoin; trioctanoin; tridecanoin; and trilaurin and mixtures thereof. Most preferably the long chain glycerol-based, hydrophobic bleach activator herein is trioctanoin.

Suitable long chain glycerol-based, hydrophobic bleach activators are commercially available under several trade names and in several grades. Mono alkanoyl glycerol derivatives such as monolauryl glycerol are available from Stepan under the trade name Kessco® or from Uniquema under the trade name of Estol®. Trialkanoyl glycerols such as trioctanoin are available from Uniquema under the trade name of Estol®, from Huls under the trade name of Myglyol®, or from Sigma Aldrich as Tricaprylin, trilauryl glycerol is sold by Huls under the trade name Dynasan® or by Sigma Aldrich as trilaurin.

The liquid compositions according to the present invention may comprise at least about 0.1% by weight of the total composition of said long chain glycerol-based, hydrophobic bleach activator. Preferably, the composition herein may comprise from about 0.1% to about 20%, preferably from about 0.5% to about 15%, more preferably from about 0.5% to about 10%, even more preferably from about 0.5% to about 7.5%, and most preferably from about 1% to about 6% by weight of the total composition of said long chain glycerol-based, hydrophobic bleach activator.

Hydrophilic Bleach Activator

As a second essential ingredient the liquid compositions according to the present invention comprise a hydrophilic bleach activator.

By “hydrophilic bleach activator” it is meant herein any bleach activator that upon perhydrolysis forms a peracid which is defined “hydrophilic”, according to the classification of peracids—into hydrophilic, hydrophobic and hydrotropic ones—reported in the Kirk-Ohtmer Encyclopedia quoted above.

Any hydrophilic bleach activator known to those skilled in the art can be used herein.

Preferably the generated peracid or mixture thereof generated by the hydrophilic bleach activator herein have an HLB of more than about 7.5, more preferably of from about 7.6 to about 15, even more preferably of from about 8 to about 15 and most preferably of from about 8.5 to about 12. A suitable way of calculating HLB values is according to Davis, for example, as described in “Surfactants and Polymers in aqueous solution” (see above). Suitable generated peracid or mixture thereof generated by the long chain glycerol-based, hydrophobic bleach activator are selected from the group consisting of : Peracetic acid (HLB value of 8.63), perepropanoic acid (HLB value of 8.15), and perepropanoic acid (HLB value of 7.68) and mixtures thereof.

Suitable hydrophilic bleach activator is selected from the group consisting of: short chain glycerol-based activator, tetracetyl ethylene diamine (TAED), acetyl triethyl citrate (ATC) and mixtures thereof.

A suitable short chain glycerol-based activator is according to the formula: 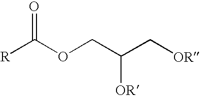
wherein R is a linear or branched, saturated or unsaturated alkyl chain with a number of carbon atoms up to about 4, or a linear or branched, saturated or unsaturated alkyl aryl chain with a number of carbon atoms up to about 6 and wherein R′ and R″ are independently —H or —COR′″, with R′″ being a linear or branched, saturated or unsaturated alkyl chain with a number of carbon atoms up to about 4, or a linear or branched, saturated or unsaturated alkyl aryl chain with a number of carbon atoms up to about 6.

Preferably R is methyl group and R′ and R″ are —COR′″, with R′″ being a methyl group.

Preferably the short chain glycerol-based activator herein is selected from the group consisting of: mono-, di- or triacetin, mono-, di- or tripropanoin, mono-, di- or tributanoin and mixtures thereof. More preferably the short chain glycerol-based activator herein is selected from the group consisting of: triacetin, tripropanoin, and tributanoin and mixtures thereof. Even more preferably the short chain glycerol-based activator herein is triacetin.

Suitable short chain glycerol-based activator are commercially such as triacetin is commercially available from Sigma Aldrich under the trade name Triacetin, or from Eastman as triacetin. ATC is commercially available under the tradename Acetyl Triethyl Citrate from Sigma-Aldrich and TAED is commercially available under the tradename Mikon ATI® from Warwick.

Provided the hydrophilic bleach activator herein is a solid compound, the solid hydrophilic bleach activator can be suspended in the liquid compositions according to the present invention. Provided hydrophilic bleach activator herein is a liquid compound that is not mixable with the liquid compositions according to the present invention, the hydrophilic bleach activator may be emulsified or dispersed in the liquid compositions according to the present invention. If said hydrophilic bleach activator herein is mixable with the liquid compositions according to the present invention, the hydrophilic bleach activator may added to the liquid composition according to the present invention as is.

The liquid compositions according to the present invention may comprise at least about 0.1% by weight of the total composition of said hydrophilic bleach activator. Preferably, the composition herein may comprise from about 0.1% to about 20%, preferably from about 0.1% to about 15%, more preferably from about 0.5% to about 15%, even more preferably from about 0.5% to about 10%, and most preferably from about 1% to about 10% by weight of the total composition of said hydrophilic bleach activator.

It has now been found that the combination in a liquid activator composition of a long chain glycerol-based, hydrophobic bleach activator with a hydrophilic bleach activator provide excellent bleach activation performance both on hydrophilic and hydrophobic stains when used in conjunction with a peroxygen bleach-containing composition. Furthermore, it has been found that the above combination is able to provide significant fabric dinginess cleaning benefits. Without being bound by theory, we speculate that this is due to the combined bleaching action of the hydrophilic and hydrophobic peracid delivered through the wash by the two bleach activators, on the variety of the chemicals that compose the dinginess on a fabric.

Product Form

The liquid compositions according to the present invention are suitable for use in conjunction with or as part of a peroxygen bleach-containing composition in a process of bleaching and/or cleaning fabrics.

In a preferred embodiment of the present invention, the liquid compositions herein are used as a stand-alone activator composition for use with a composition comprising a peroxygen bleach. The composition comprising a peroxygen bleach may be a conventional peroxygen bleach-containing laundry detergent, such as Tide with Bleach®, Ariel®, and the like. The conventional peroxygen bleach-containing laundry detergent may be in any given form such as a powder, liquid, gel, tablet or liquid single dose pouch. Alternatively, the composition comprising a peroxygen bleach may be a laundry bleach additive comprising a peroxygen bleach, such as ACE Gentle Bleach®, ACE color powder®, Clorox 2®, and the like.

In this preferred embodiment, the liquid compositions herein may comprise one or more optional ingredients as outlined herein below. In a preferred embodiment, the liquid compositions herein are free of a peroxygen bleach.

In this preferred embodiment the liquid compositions herein may be in the form of a liquid or gel, aqueous or non-aqueous composition contained in a bottle or a, preferably non-aqueous, composition contained in water-soluble pouch.

In this preferred embodiment the pH of the aqueous compositions herein, as is measured at 25° C., preferably is at least, with increasing preference in the order given, about 5, about 5.5, about 6, about 6.5 or about 6.9. Independently, the pH of the liquid bleaching compositions herein, as is measured at 25° C., preferably is no more than, with increasing preference in the order given, about 9, about 8.5, about 8, about 7.5, about 7 or about 7.1.

In another preferred embodiment the present invention, the liquid compositions herein additionally comprise a peroxygen bleach. In this preferred embodiment, the liquid compositions herein are activated bleaching compositions suitable for use as a laundry bleach additive.

In this preferred embodiment the long chain glycerol-based, hydrophobic bleach activator and the hydrophilic bleach activator present in the liquid composition additionally comprising a peroxygen bleach, are preferably separated from said peroxygen bleach. In this preferred embodiment, the liquid compositions herein are activated bleaching compositions suitable for use as a laundry bleach additive.

By “separation” it is meant herein, that upon storage the bleach activators do not come in immediate contact with the peroxygen bleach. Indeed, it has been found that such a separation prevents the premature activation of the peroxygen bleach by the bleach activators. Suitable means to separate the long chain glycerol-based, hydrophobic bleach activator and the hydrophilic bleach activator from the peroxygen bleach in the liquid composition are selected from the group consisting of: formation of a an emulsion or microemulsion, wherein the long chain glycerol-based, hydrophobic bleach activator and the hydrophilic bleach are in a separate phase as compared to the peroxygen bleach; encapsulation of the long chain glycerol-based, hydrophobic bleach activator and the hydrophilic bleach together in one encapsulate or in two separate encapsulates; encapsulation of the peroxygen bleach; encapsulation of the bleach activators and the peroxygen bleach in different encapsulates; solid-liquid phase separation in a non aqueous matrix, wherein the long chain glycerol-based, hydrophobic bleach activator is in the liquid oily form while the peroxygen bleach and the hydrophilic bleach activator are in the solid form suspended in the oily liquid hydrophobic bleach; solid-liquid phase separation in a non aqueous matrix, wherein the long chain glycerol-based, hydrophobic bleach activator and the hydrophilic bleach activator (such as triacetin) are in the liquid oily form while the peroxygen bleach is in the solid form suspended in the oily liquid hydrophobic bleach; multiphase (i.e., solid and liquid phase) mono-compartment water-soluble pouches wherein the peroxygen bleach and the hydrophilic bleach activator are in a solid phase that is suspended in an oily liquid phase comprising the long chain glycerol-based, hydrophobic bleach activator or; multiphase (i.e., solid and liquid phase) mono-compartment water-soluble pouches wherein the peroxygen bleach is in a solid phase that is suspended in an oily liquid phase comprising the long chain glycerol-based, hydrophobic bleach activator and the hydrophilic bleach activator.

A suitable process to form encapsulates for use herein is for example described in EP-A-874 896.

In this preferred embodiment the liquid compositions herein additionally comprising a peroxygen bleach may be in the form of a liquid or gel, aqueous or non-aqueous composition contained in a bottle or a, preferably non-aqueous, composition contained in water-soluble pouch.

In this preferred embodiment the pH of the aqueous compositions herein, as is measured at 25° C., preferably is at least, with increasing preference in the order given, about 0.1, about 0.5, about 1, about 1.5, about 2, about 2.5, about 3, about 3.5, or about 4. Independently, the pH of the liquid bleaching compositions herein, as is measured at 25° C., preferably is no more than, with increasing preference in the order given, about 9, about 8.5, about 8, about 7.5, about 7, about 6.5, about 6, about 5.5 or about 5.

In yet another preferred embodiment the present invention, the liquid compositions herein form part of a product or kit that additionally comprises a second composition comprising a peroxygen bleach. This specific embodiment can be referred to as a dual or multiple compartment execution, wherein the liquid composition is present in a first compartment of a product and the composition comprising a peroxygen bleach is present in a second compartment. The composition comprising a peroxygen bleach, which is present in a second compartment, may be in a liquid, solid or gel form.

Suitable multiple compartment executions are selected from the group consisting of: multiple compartment bottles, preferably dual compartment bottles comprising the liquid composition according to the present invention in one compartment and a composition comprising a peroxygen bleach in another compartment; multiple compartment water-soluble pouches comprising the liquid composition according to the present invention in one compartment and a composition comprising a peroxygen bleach in another compartment or; multiphase tablets containing a gel capsule comprising the liquid composition according to the present invention and a compressed powder containing a peroxygen bleach;

A suitable dual compartment bottle for use herein is for example described in EP-A-744 462.

In this preferred embodiment the pH of the aqueous compositions herein, as is measured at 25° C., preferably is at least, with increasing preference in the order given, about 5, about 5.5, about 6, about 6.5 or about 6.9. Independently, the pH of the liquid bleaching compositions herein, as is measured at 25° C., preferably is no more than, with increasing preference in the order given, about 9, about 8.5, about 8, about 7.5, about 7 or about 7.1.

Optional Ingredients

As mentioned herein above, the liquid compositions according to the present invention as well as additional compositions, if any, forming part of the same product or kit may comprise a series of optional ingredients.

Peroxygen Bleach

One highly preferred optional ingredient herein is a peroxygen bleach.

Suitable peroxygen bleaches to be used herein are selected from the group consisting of: hydrogen peroxide; water soluble sources of hydrogen peroxide; organic or inorganic peracids; hydroperoxides; diacyl peroxides; and mixtures thereof.

As used herein a hydrogen peroxide source refers to any compound that produces perhydroxyl ions on contact with water. Suitable water-soluble sources of hydrogen peroxide for use herein include percarbonates, perborates and persilicates and mixtures thereof.

Suitable diacyl peroxides for use herein include aliphatic, aromatic and aliphatic-aromatic diacyl peroxides, and mixtures thereof.

Suitable aliphatic diacyl peroxides for use herein are dilauroyl peroxide, didecanoyl peroxide, dimyristoyl peroxide, or mixtures thereof. A suitable aromatic diacyl peroxide for use herein is for example benzoyl peroxide. A suitable aliphatic-aromatic diacyl peroxide for use herein is for example lauroyl benzoyl peroxide.

Suitable organic or inorganic peracids for use herein include : persulphates such as monopersulfate; peroxyacids such as diperoxydodecandioic acid (DPDA); magnesium perphthalic acid; perlauric acid; phthaloyl amidoperoxy caproic acid (PAP); perbenzoic and alkylperbenzoic acids; and mixtures thereof.

Suitable hydroperoxides for use herein are tert-butyl hydroperoxide, cumyl hydroperoxide, 2,4,4-trimethylpentyl-2-hydroperoxide, di-isopropylbenzene-monohydroperoxide, tert-amyl hydroperoxide and 2,5-dimethyl-hexane-2,5-dihydroperoxide and mixtures thereof. Such hydroperoxides have the advantage of being particularly safe to fabrics and color while delivering excellent bleaching performance when used in any laundry application.

A preferred peroxygen bleach herein is selected from the group consisting of: hydrogen peroxide; water-soluble sources of hydrogen peroxide; organic or inorganic peracids; hydroperoxides; and diacyl peroxides; and mixtures thereof. A more preferred peroxygen bleach herein is selected from the group consisting of hydrogen peroxide, water-soluble sources of hydrogen peroxide and diacyl peroxides and mixtures thereof. An even more preferred peroxygen bleach herein is selected from the group consisting of hydrogen peroxide, water soluble sources of hydrogen peroxide, aliphatic diacyl peroxides, aromatic diacyl peroxides and aliphatic-aromatic diacyl peroxides and mixtures thereof. The most preferred peroxygen bleach herein is hydrogen peroxide, water-soluble sources of hydrogen peroxide or mixtures thereof

The compositions according to the present invention comprise at least 1% of available H₂O₂ by weight of the total composition. Preferably, the composition herein may comprise from about 1% to about 30%, preferably from about 2% to about 25%, more preferably from about 2% to about 20%, even more preferably from about 2.5% to about 20%, and most preferably from about 2.5% to about 18% of available H₂O₂ by weight of the total composition.

Lipophilic Bleach Booster

An optional ingredient for use herein is a lipophilic bleach booster or a mixture thereof.

Bleach boosters provide increased bleaching effectiveness in lower temperature applications. The bleach boosters act in conjunction with conventional peroxygen bleaching sources to provide increased bleaching effectiveness. This is normally accomplished through in situ formation of an active oxygen transfer agent such as a dioxirane, an oxaziridine, or an oxaziridinium. Alternatively, preformed dioxiranes, oxaziridines and oxaziridiniums may be used.

By an “lipophilic” bleach booster it is meant herein a bleach booster is of lipophilic nature and which is preferably soluble in an oily phase.

Among suitable lipophilic bleach booster for use in accordance with the present invention are cationic imines, zwitterionic imines, anionic imines and/or polyionic imines having a net charge of from about +3 to about −3, and mixtures thereof. These imine lipophilic bleach booster of the present invention include those of the general structure: 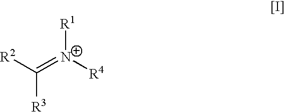
where R¹—R⁴ may be a hydrogen or an unsubstituted or substituted radical selected from the group consisting of phenyl, aryl, heterocyclic ring, alkyl and cycloalkyl radicals.

Among preferred lipophilic bleach booster are zwitterionic bleach boosters, which are described in U.S. Pat. Nos. 5,576,282 and 5,718,614 (both incorporated herein by reference). Other lipophilic bleach booster include cationic bleach boosters described in U.S. Pat. Nos. 5,360,569, 5,442,066, 5,478,357, 5,370,826, 5,482,515, 5,550,256, and WO 95/13351, WO 95/13352, and WO 95/13353 (all of the above are incorporated herein by reference).

Preferred lipophilic bleach booster herein are selected from the group consisting of: 3-(3,4-Dihydroisoquinolinium)propane sulfonate (DIPS), 4-3,4-Dihydroisoquinolinium)butane sulfonate, 4-[(2-ethylhexyloxymethyl]-1,3,2-dioxathiolane-2,2-dione, Sulfuric acid mono-[2-(3,4-dihydro-isoquinolin-2-yl)-1-(2-ethyl-hexyloxymethyl)-ethyl]ester, Sulfuric acid mono-[2-(3,4-dihydro-isoquinolin-2-yl)-1-(octyloxymethyl)-ethyl]ester, Sulfuric acid mono-[2-(3,4-dihydro-isoquinolin-2-yl)-1-(decyloxymethyl)-ethyl]ester, Sulfuric acid mono-[2-(3,4-dihydro-isoquinolin-2-yl)-1-(9-deceneoxymethyl)-ethyl]ester, Sulfuric acid mono-[2-(3,4-dihydro-isoquinolin-2-yl)-1-(2,2,3,3,4,4,4-heptafluorobutyloxymethyl)-ethyl]ester, 3-{3-[1,1-bis(methylethyl)-2-methyl-1-silapropoxy]propoxy}-2-(2-3,4-dihydroisouinolylmethyl)-propanesulfonic acid, Sulfuric acid mono-{2-(3,4-dihydro-isoquinolin-2-yl)-1-[2-(2-hexyloxy-ethoxy)-ethoxymethyl]-ethyl}ester, and Sulfuric acid mono-[1-(3,4-dihydro-isoquinolin-2-yl)-decan-2-yl]ester (O-DIES), and mixtures thereof. An even more preferred lipophilic bleach booster herein is selected from the group consisting of: 3-(3,4-Dihydroisoquinolinium)propane sulfonate (DIPS), Sulfuric acid mono-[2-(3,4-dihydro-isoquinolin-2-yl)-1-(2-ethyl-hexyloxymethyl)-ethyl]ester, and Sulfuric acid mono-[1-(3,4-dihydro-isoquinolin-2-yl)-decan-2-yl]ester, and mixtures thereof. The most preferred lipophilic bleach booster herein is Sulfuric acid mono-[2-(3,4-dihydro-isoquinolin-2-yl)-1-(2-ethyl-hexyloxymethyl)-ethyl]ester.

Typically, the compositions herein may comprise from about 0.001% to about 2%, preferably from about 0.01% to about 1.% , more preferably from about 0.02% to about 0.5% and most preferably from about 0.02% to about 0.2% by weight of the total composition of a lipophilic bleach booster

It has surprisingly been found that the long chain glycerol-based, hydrophobic bleach activator herein in addition to their performance as a bleach activator may also act as solvent and/or carrier for lipophilic bleach booster. Indeed, it has been found that the action of such a lipophilic bleach booster is facilitated. Without being bound by theory, it has been observed that the long chain glycerol-based, hydrophobic bleach activator herein transports and/or facilitates the access of lipophilic bleach booster to hydrophobic entities such as hydrophobic, bleachable stains or hydrophobic parts of the fabric and thereby improves the performance of the lipophilic bleach boosters.

Surfactants

An optional ingredient for use herein is a surfactant.

Typically, the compositions herein may comprise from about 0.01% to about 30%, preferably from about 0.1% to about 25 % and more preferably from about 0.5% to about 20% by weight of the total composition of a surfactant.

Suitable nonionic surfactants include alkoxylated nonionic surfactants. Preferred alkoxylated nonionic surfactants herein are ethoxylated nonionic surfactants according to the formula RO—(C₂H₄O)ₙH, wherein R is a about C₆ to about C₂₂ alkyl chain or a about C₆ to about C₂₈ alkyl benzene chain, and wherein n is from 0 to about 20, preferably from about 1 to about 15 and, more preferably from about 2 to about 15 and most preferably from about 2 to about 12. The preferred R chains for use herein are the about C₈ to about C₂₂ alkyl chains. Propoxylated nonionic surfactants and ethoxy/propoxylated ones may also be used herein instead of the ethoxylated nonionic surfactants as defined herein above or together with said surfactants.

Suitable substantially linear ethoxylated nonionic surfactants for use herein are available in the Marlipal® surfactant series commercially available from Condea. Suitable alkoxylated nonionic surfactants for use herein are available in the Dobanol® surfactants series commercially available from SHELL, the Lutensol® surfactants series commercially available from BASF and the Tergitol® surfactants series commercially available from UNION CARBIDE.

Other suitable nonionic surfactants to be used herein include polyhydroxy fatty acid amide surfactants, available under the trade name HOE® from Hoechst.

Suitable zwitterionic betaine surfactants for use herein contain both a cationic hydrophilic group, i.e., a quaternary ammonium group, and anionic hydrophilic group on the same molecule at a relatively wide range of pH's. The typical anionic hydrophilic groups are carboxylates and sulphonates, although other groups like sulfates, phosphonates, and the like can be used. Some common examples of betaine/sulphobetaine are described in U.S. Pat. Nos. 2,082,275, 2,702,279 and 2,255,082. (all of the above are incorporated by reference herein)

Suitable anionic surfactants to be used in the compositions herein include water-soluble salts or acids of the formula ROSO₃M wherein R preferably is a about C₁₀ to about C₂₄ hydrocarbyl, preferably an alkyl or hydroxyalkyl having a about C₁₀ to about C₂₀ alkyl component, more preferably a about C₁₂ to about C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Other suitable anionic surfactants for use herein are water-soluble salts or acids of the formula RO(A)ₘSO₃M wherein R is an unsubstituted about C₁₀ to about C₂₄ alkyl or hydroxyalkyl group having a about C₁₀ to about C₂₄ alkyl component, preferably a about C₁₂ to about C₂₀ alkyl or hydroxyalkyl, more preferably about C₁₂ to about C₁₈ alkyl or hydroxyalkyl, A is an ethoxy or propoxy unit, m is greater than zero, typically between about 0.5 and about 6, more preferably between about 0.5 and about 3, and M is H or a cation which can be, e.g., a metal cation (e.g., sodium, potassium, lithium, calcium, magnesium, etc.), ammonium or substituted-ammonium cation. Alkyl ethoxylated sulfates as well as alkyl propoxylated sulfates are contemplated herein.

Other suitable anionic surfactants for use herein are sulphonated anionic surfactants Suitable sulphonated anionic surfactants for use herein include alkyl sulphonates, alkyl aryl sulphonates, naphthalene sulphonates, alkyl alkoxylated sulphonates, C₆-C₂₀ alkyl alkoxylated linear or branched diphenyl oxide disulphonates, or mixtures thereof.

Suitable alkyl or alkyl aryl sulphonates for use herein include water-soluble salts or acids of the formula RSO₃M wherein R is a about C₆ to about C₂₀ linear or branched, saturated or unsaturated alkyl group, preferably a about C₈ to about C₁₈ alkyl group and more preferably a about C₁₄ to about C₁₇ alkyl group, or wherein R is an aryl, preferably a benzyl, substituted by a about C₆ to about C₂₀ linear or branched saturated or unsaturated alkyl group, preferably a about C₈ to about C₁₈ alkyl group and more preferably a about C₁₀ to about C₁₆ alkyl group, and M is H or a cation, e.g., an alkali metal cation (e.g., Na, K, Li), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable alkyl sulphonates include about C₁₄ to about C₁₇ paraffin sulphonate like Hostapur® SAS commercially available from Hoechst. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright & Wilson.

Suitable alkoxylated sulphonate surfactants for use herein are according to the formula R(A)ₘSO₃M wherein R is an unsubstituted about C₆ to about C₂₀ alkyl, hydroxyalkyl or alkyl aryl group, having a linear or branched about C₆ to about C₂₀ alkyl component, preferably a about C₁₂ to about C₂₀ alkyl or hydroxyalkyl, more preferably about C₁₂ to about C₁₈ alkyl or hydroxyalkyl, A is an ethoxy or propoxy or butoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Particularly suitable alkoxylated sulphonates include alkyl aryl polyether sulphonate like Triton X-200® commercially available from Union Carbide.

Other anionic surfactants suitable herein include sulfosuccinate surfactants, alkyl carboxylate surfactants, sulfosuccinamate surfactants and sulfosuccinamide surfactants.

Suitable amphoteric surfactants to be used herein include amine oxides having the following formula R₁R₂R₃NO wherein each of R₁, R₂ and R₃ is independently a saturated substituted or unsubstituted, linear or branched hydrocarbon chains of from about 1 to about 30 carbon atoms. Suitable amine oxides for use herein are for instance natural blend C₈-C₁₀ amine oxides as well as C₁₂-C₁₆ amine oxides commercially available from Hoechst.

Dye Maintenance Agent

An optional ingredient for use herein is a dye maintenance agent.

Any dye maintenance agent known to those skilled in the art are suitable for use herein.

Suitable dye maintenance agents are described as cyclic amine based polymers, oligomers or copolymers in WO 99/14301 and dye maintenance polymers or oligomers in WO 00/56849 (both incorporated by reference herein).

Typically, the compositions herein may comprise from about 0.001% to about 30%, preferably from about 0.01 % to about 15% and more preferably from about 0.05% to about 5% by weight of the total composition of a dye maintenance agent.

Anti-Resoiling Polymers

An optional ingredient for use herein is an anti-resoiling polymer.

Suitable anti-resoiling polymers include soil suspending polyamine polymers. Particularly suitable polyamine polymers for use herein are alkoxylated polyamines. Such materials can conveniently be represented as molecules of the empirical structures with repeating units: 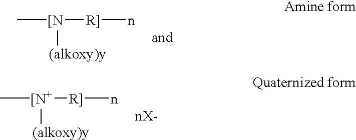
wherein R is a hydrocarbyl group, usually of about 2 to about 6 carbon atoms; R₁ may be a C₁-C₂₀ hydrocarbon; the alkoxy groups are ethoxy, propoxy, and the like, and y is from about 2 to about 30, most preferably from about 7 to about 20; n is an integer of at least about 2, preferably from about 2 to about 40, most preferably from about 2 to about 5; and X— is an anion such as halide or methylsulfate, resulting from the quaternization reaction. Highly preferred polyamines for use herein are the so-called ethoxylated polyethylene amines, i.e., the polymerized reaction product of ethylene oxide with ethyleneimine, having the general formula: 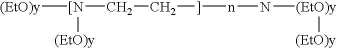
wherein y is from about 2 to about 50, preferably from about 5 to about 30, and n is from about 1 to about 40, preferably from about 2 to about 40. Particularly preferred for use herein is an ethoxylated polyethylene amine, in particular an ethoxylated polyethylene amine wherein n=2 and y=20, and an ethoxylated polyethylene amine wherein n=40 and y=7.

Suitable ethoxylated polyethylene amines are commercially available from Nippon Shokubai CO., LTD under the product names ESP-0620A® (ethoxylated polyethylene amine wherein n=2 and y=20) or from BASF under the product names ES-8165 and from BASF under the product name LUTENSIT K-187/50® (ethoxylated polyethylene amine wherein n=40 and y=7).

Furthermore, highly preferred polyamines for use herein are the so called ethoxylated polyethylene quaternized amines having the general formula: 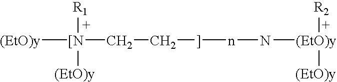
wherein y is from about 2 to about 50, preferably from about 5 to about 30, and n is from about 1 to about 40, preferably from about 2 to about 40 and R1 and R2 are independently a about C₁ to about C₂₀ hydrocarbon. Particularly preferred for use herein is an ethoxylated polyethylene amine, in particular an ethoxylated polyethylene amine wherein n=2 and y=20, and an ethoxylated polyethylene amine wherein n=40 and y=7.

Particularly preferred herein is 24-Ethoxylated Hexamethylene Diamine Quaternized methyl chloride (EHDQ), commercially available from BASF under the trade name Lutensit K-HD 96®.

Alkoxylated Benzoic Acid

An optional ingredient for use herein is an alkoxylated benzoic acid or a salt thereof

Generally, the alkoxylated benzoic acid or the salt thereof has the general formula: 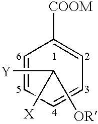
wherein : the substituents of the benzene ring X and Y are independently selected from —H, or —OR′; R′ is independently selected from about C₁ to about C₂₀ linear or branched alkyl chains.

In a highly preferred embodiment of the present invention, said alkoxylated benzoic acid or the salt thereof is a trimethoxy benzoic acid or a salt thereof (TMBA), wherein in the above general formula: the substituents of the benzene ring Y and X are —OR′; R′ is —CH₃ and; M is hydrogen, a cation or a cationic moiety.

Suitable alkoxylated benzoic acids or salts thereof are commercially available from Aldrich and Merck.

Typically, the composition according to the present invention may comprise from about 0.001% to about 5%, preferably from about 0.005% to about 2.5% and more preferably from about 0.01% to about 1.0% by weight of the total composition of said alkoxylated benzoic acid or a salt thereof.

Chelating Agents

An optional ingredient for use herein is a chelating agent. Suitable chelating agents may be any of those known to those skilled in the art, such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof.

Suitable phosphonate chelating agents to be used herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. (incorporated herein by reference). Preferred compounds of this type in acid form are dihydroxydisulfobenzenes such as 1,2-dihydroxy -3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer, have been extensively described in U.S. Pat. No. 4,704,233, Nov. 3, 1987, to Hartman and Perkins (incorporated by reference herein). Ethylenediamine N,N′-disuccinic acid is commercially available as ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available as Trilon FS® from BASF and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula: 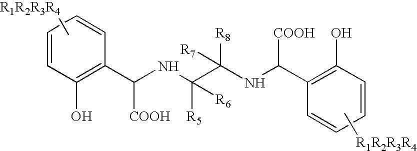
wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the compositions according to the present invention may comprise up to about 5%, preferably from about 0.01% to about 1.5% by weight and more preferably from about 0.01% to about 0.5% by weight of the total composition of a chelating agent.

Other Optional Ingredients

The compositions herein may further comprise a variety of optional ingredients such as thickeners, builders, stabilisers, soil suspenders, sulphonated hydrotropes, foam reducing systems or agents, catalysts, dye transfer agents, brighteners, perfumes, solvents, pigments and dyes.

Process of Treating Fabrics

The liquid composition of the present invention is used by contacting fabrics with said composition in neat form or in diluted form.

The compositions according to the present invention are typically used in diluted form in a laundry operation. By “in diluted form” it is meant herein that the compositions according to the present invention may be diluted with a solvent by the user, preferably with water. Such dilution may occur for instance in soaking applications as well as by other means such as in a washing machine. Said compositions may be used at a dilution level of up to about 1500:1 (solvent: composition), preferably from about 5:1 to about 1000:1 and more preferably from about 10:1 to about 700:1 (solvent:composition).

By “in neat form”, it is to be understood that the liquid compositions are applied directly onto the fabrics to be treated without undergoing any dilution, i.e., the liquid compositions herein are applied onto the fabrics as described herein.

Fabrics to be treated herein include, but are not limited to, clothes, curtains, drapes, bed linens, bath linens, tablecloths, sleeping bags and/or tents.

By “treating a fabric”, it is meant herein cleaning said fabric.

Depending on the product form as described herein above in the section “Product form” it may be necessary to combine the liquid compositions herein with a peroxygen bleach-containing composition prior and/or during the process of treating fabrics as described herein. Furthermore, for practical reasons it may occur that certain product forms are less suitable for certain treatment modes as described herein below. Indeed, water-soluble pouches, multiple compartment products containing non-liquid peroxygen-bleach-containing compositions may be less suitable for use in the below detailed pretreatment mode.

In the process of treating (e.g., cleaning and/or bleaching) a fabric, a liquid composition according to the present invention is contacted with the fabrics to be treated.

This can be done either in a so-called “pretreatment mode”, where a liquid composition, as defined herein, is applied neat onto said fabrics before the fabrics are washed or in a “soaking mode” where a liquid composition, as defined herein, is first diluted in an aqueous bath and the fabrics are immersed and soaked in the bath, before they are washed, or in a “through-the-wash mode”, where a liquid composition, as defined herein, is added in addition to a wash liquor formed by dissolution or dispersion of a conventional laundry detergent, preferably in a washing machine.

In the process herein, said fabrics are to be washed, i.e., treated with a conventional laundry detergent, preferably comprising at least one surface active agent, the washing of said fabrics with a conventional laundry detergent may be conducted before the step of contacting said fabrics with the composition herein and/or during the step of contacting fabrics are contacted with the composition herein and/or after the step where said fabrics are contacted with the composition herein.

In a preferred embodiment, the washing step according to the present invention is performed in a washing machine. The conventional detergent composition may be delivered into the washing machine either by charging the dispenser drawer of the washing machine with the detergent or by directly charging the drum of the washing machine with the detergent.

By “conventional laundry detergent” it is meant herein, a laundry detergent composition, preferably a powder, liquid or tablet composition, currently available on the market. Preferably, said conventional laundry detergent comprises at least one surface active agent. Suitable laundry detergent compositions are for example DASH futur®, DASH essential®), DASH liquid®, ARIEL tablets® and other products sold under the trade names ARIEL® or TIDE®.

### EXAMPLES

The following Examples are meant to exemplify compositions used in a process according to the present invention but are not necessarily used to limit or otherwise define the scope of the present invention. The compositions are made by combining the listed ingredients in the listed proportions (weight % unless otherwise specified).

| | Examples | | | | |
|---|---|---|---|---|---|
| | I | II | III | IV | V |
| Marlipal 24.7 ® | 5.0 | 3.0 | 3.0 | 4.0 | 5.0 |
| C12 Alkyl sulphate | 0.0 | 2.9 | 0.0 | 0.0 | 0.0 |
| Neodol 91.8 ® | 0.0 | 1.0 | 0.0 | 1.0 | 0.0 |
| Neodol 45.7 ® | 0.0 | 0.0 | 1.5 | 0.0 | 0.0 |
| Sokalan CP5 ® | 3.5 | 3.5 | 3.0 | 3.5 | 3.5 |
| Xanthan Gum | 0.0 | 0.5 | 0.4 | 0.5 | 0.5 |
| Acusol 425 ® | 1.0 | 1.5 | 1.0 | 1.0 | 1.0 |
| Triacetin | 6.0 | 5.0 | 5.5 | 6.0 | 0.0 |
| TAED | 0.0 | 0.0 | 0.0 | 0.0 | 5.0 |
| Trioctanoin | 4.0 | 3.0 | 3.5 | 4.0 | 4.0 |
| Lipophilic Bleach Booster* | 0.1 | 0.0 | 0.1 | 0.1 | 0.1 |

| | |
|---|---|
| Water and minors | up to 100% |

All examples have a pH of 7

Example compositions I-V are so-called activator compositions to be used in conjunction with a separate peroxygen bleach-containing composition or in a multiple compartment product.

Examples

| | VI | VII | VIII | IX |
|---|---|---|---|---|
| Hydrogen peroxide | 7.0 | 7.0 | 7.5 | 6.5 |
| Marlipal 24.7 ® | 9.0 | 5.0 | 6.0 | 7.0 |
| Neodol 91.8 ® | 0.0 | 2.0 | 3.0 | 1.0 |
| Neodol 45.7 ® | 0.0 | 2.0 | 0.0 | 1.0 |
| Sokalan CP5 ® | 3.5 | 3.0 | 3.0 | 3.5 |
| Lutensit KHD-96 ® | 6.0 | 5.0 | 6.0 | 6.0 |
| Xanthan Gum | 0.0 | 0.5 | 0.5 | 0.5 |
| Acusol 425 ® | 1.0 | 1.5 | 1.0 | 1.0 |
| Triacetin | 6.0 | 0.0 | 0.0 | 6.0 |
| TAED | 0.0 | 5.0 | 5.0 | 0.0 |
| Trioctanoin | 4.0 | 4.0 | 4.0 | 4.0 |
| Lipophilic Bleach Booster* | 0.1 | 0.1 | 0.1 | 0.0 |

| | |
|---|---|
| Water and minors | up to 100% |

All examples have a pH of below 9

Example compositions VI-IX are activated bleaching compositions wherein the bleach activators herein are separated from the peroxygen bleach. The separation is by means of forming an oil-in-water or water-in-oil emulsion wherein the hydrogen peroxide is in the water phase of the emulsion.

Examples

| | X | XI | XII | XIII |
|---|---|---|---|---|
| Sodium Percarbonate | 30 | 25 | 35 | 35 |
| NaLAS | 1.7 | 1.7 | 1.7 | 1.7 |
| Sodium Sulfate | 14.7 | 14.7 | 14.7 | 14.7 |
| Sokalan CP5 ® | 2.9 | 2.9 | 2.9 | 2.9 |
| Lutensit KHD-96 ® | 5.0 | 6.0 | 5.0 | 6.0 |
| Zeolite | 15.2 | 15.2 | 15.2 | 15.2 |
| TAED | 6.3 | 5.0 | 6.0 | 5.0 |
| Trioctanoin | 4.0 | 4.5 | 4.0 | 4.0 |
| Lipophilic Bleach Booster* | 0.1 | 0.1 | 0.0 | 0.1 |

| | |
|---|---|
| Sodium Carbonate and minors | up to 100% |

Examples X-XIII describe solid bleaching compositions wherein the wherein the liquid composition comprising a long chain glycerol-based, hydrophobic bleach activator and a hydrophilic bleach activator according to the present invention is applied to, preferably sprayed onto, a solid composition.

Examples

| | XIV | XV | XVI | XVII |
|---|---|---|---|---|
| Compartment 1 | | | | |
| Triacetin | 6.0 | 6.5 | 6.0 | 6.0 |
| Trioctanoin | 4.0 | 4.5 | 4.0 | 4.0 |
| Marlipal 24.7 ® | 5.0 | 5.0 | 0.0 | 2.0 |
| Neodol 91.8 ® | 0.0 | 0.0 | 3.0 | 2.0 |
| Neodol 45.7 ® | 0.0 | 0.0 | 2.0 | 1.0 |
| C12 Alkyl sulphate | 2.9 | 2.9 | 0.0 | 2.0 |
| Sokalan CP5 ® | 3.5 | 3.5 | 3.5 | 3.5 |
| Acusol 425 ® | 1.0 | 1.0 | 1.0 | 1.0 |
| Xanthan Gum | 0.5 | 0.5 | 0.5 | 0.5 |
| Lipophilic Bleach Booster* | 0.1 | 0.2 | 0.1 | 0.1 |
| Water and minors | up to 100% | | | |
| Compartment 2 | | | | |
| Hydrogen peroxide | 8.0 | 7.9 | 7.9 | 8.0 |
| Marlipal 24.7 ® | 9.0 | 9.0 | 7.0 | 7.0 |
| Lutensit KHD-96 ® | 6.0 | 5.0 | 5.0 | 6.0 |

| | |
|---|---|
| Water and minors | up to 100% |

Compositions in Compartment 1 have a pH of 7
Compositions in Compartment 2 have a pH of 4

Example compositions XIV-XVIII are packed in a dual compartment bottle, such as shown in EP-A-744 462, thereby the activators are physically separated from the hydrogen peroxide.

Marlipal® 24.7 is a linear C₁₂-C₁₄ EO7 nonionic surfactant commercially available from Condea.

Dobanol® 45-7 is a C₁₄-C₁₅ EO7 nonionic surfactant, Dobanol® 91-8 is a C₉-C₁₁ EO8 nonionic surfactant, Neodol 23.3® is a C₁₂-C₁₃ EO3 nonionic surfactant and Neodol 45.7® is a C₁₄-C₁₅ EO7 nonionic surfactant, all are commercially available from SHELL.

Acusol 425® is a modified polycarboxylate co-builder commercially available from Rohm & Haas.

Na LAS is a Sodium Linear Alky Benzene Sulphonate.

TAED is tetracetyl ethylene diamine.

Lutensit KHD-96® is 24-Ethoxylated Hexamethylene Diamine Quaternized methyl chloride commercially available from BASF.

Lipophilic Bleach Booster* is Sulfuric acid mono-[2-(3,4-dihydro-isoquinolin-2-yl)-1-(2-ethyl-hexyloxymethyl)-ethyl]ester.

Sokalan CP5® is an acrylic acid/maleic acid copolymer commercially available from BASF.

1. A liquid composition comprising a long chain glycerol-based, hydrophobic bleach activator capable of generating a peracid and a hydrophilic bleach activator.

2. A liquid composition according to claim 1, wherein the generated peracid generated by said long chain glycerol-based, hydrophobic bleach activator has an HLB of at utmost about 7.5.

3. A liquid composition according to claim 1, wherein said long chain glycerol-based, hydrophobic bleach activator is according to the formula: 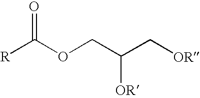
wherein R is a linear or branched, saturated or unsaturated alkyl chain with a number of carbon atoms between about 5 and about 20, or a linear or branched, saturated or unsaturated alkyl aryl chain with a number of carbon atoms between about 9 and about 20 and wherein R′ and R″ are independently —H or —COR′″, with R′″ being a linear or branched, saturated or unsaturated alkyl chain with a number of carbon atoms between about 5 and about 20, or a linear or branched, saturated or unsaturated alkyl aryl chain with a number of carbon atoms between about 9 and about 20.

4. A liquid composition according to claim 1, wherein said long chain glycerol-based, hydrophobic bleach activator is selected from the group consisting of: triesanoin; mono- di- or trioctanoin; mono- di- or tridecanoin; and mono- di- or trilaurin and mixtures thereof.

5. A liquid composition comprising a long chain glycerol-based, hydrophobic bleach activator and a hydrophilic bleach activator, wherein said long chain glycerol-based, hydrophobic bleach activator is selected from the group consisting of: triesanoin; mono- di- or trioctanoin; mono- di- or tridecanoin; and mono- di- or trilaurin and mixtures thereof.

6. A liquid composition according to claim 1, wherein the generated peracid or mixture thereof, generated by said hydrophilic bleach activator has an HLB of more than about 7.5.

7. A liquid composition according to claim 1, wherein said hydrophilic bleach activator is selected from the group consisting of: short chain glycerol-based activator, tetracetyl ethylene diamine (TAED), acetyl triethyl citrate (ATC) and mixtures thereof.

8. A liquid composition comprising a long chain glycerol-based, hydrophobic bleach activator and a hydrophilic bleach activator, wherein said hydrophilic bleach activator is selected from the group consisting of: short chain glycerol-based activator, tetracetyl ethylene diamine (TAED), acetyl triethyl citrate (ATC) and mixtures thereof.

9. A liquid composition according to claim 1, wherein said hydrophilic bleach activator is a short chain glycerol-based activator having the formula: 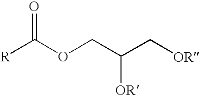
wherein R is a linear or branched, saturated or unsaturated alkyl chain with a number of carbon atoms up to about 4, or a linear or branched, saturated or unsaturated alkyl aryl chain with a number of carbon atoms up to 6 and wherein R′ and R″ are independently —H or —COR′″, with R′″ being a linear or branched, saturated or unsaturated alkyl chain with a number of carbon atoms up to about 4, or a linear or branched, saturated or unsaturated alkyl aryl chain with a number of carbon atoms up to about 6.

10. A liquid composition according to claim 9, wherein said short chain glycerol-based activator is selected from the group consisting of: mono-, di- or triacetin, mono-, di- or tripropanoin, mono-, di- or tributanoin and mixtures thereof.

11. A liquid composition comprising a long chain glycerol-based, hydrophobic bleach activator and a hydrophilic bleach activator, wherein said hydrophilic bleach activator is a short chain glycerol-based activator selected from the group consisting of: mono-, di- or triacetin, mono-, di- or tripropanoin, mono-, di- or tributanoin and mixtures thereof.

12. A liquid composition according to claim 1, wherein said liquid composition additionally comprises a lipophilic bleach booster or a mixture thereof.

13. A liquid composition according to claim 12, wherein said lipophilic bleach booster is selected from the group consisting of: cationic imines, zwitterionic imines, anionic imines and polyionic imines, all having a net charge of from +3 to −3, and mixtures thereof.

14. A liquid composition according to claim 12, wherein said lipophilic bleach booster is selected from the group consisting of: 3-(3,4-Dihydroisoquinolinium)propane sulfonate (DIPS), Sulfuric acid mono-[2-(3,4-dihydro-isoquinolin-2-yl)-1-(2-ethyl-hexyloxymethyl)-ethyl] ester, and Sulfuric acid mono-[1-(3,4-dihydro-isoquinolin-2-yl)-decan-2-yl] ester, and mixtures thereof.

15. A method of forming a cleaning composition said method comprising the step of combining the liquid composition according to claim 1, with a peroxygen bleach.

16. A liquid composition according to claim 1, wherein said liquid composition additionally comprises a peroxygen bleach.

17. A product or kit comprising a liquid composition according to claim 1 and a peroxygen bleach.

18. A solid composition comprising a liquid composition according to claim 1.

19. A solid composition according to claim 18, wherein said solid composition is a powder composition.
